(19) United States
(12) Patent Application Publication
(10) Pub. No.: US 2007/0110870 A1
(43) Pub. Date: May 17, 2007

(54) DRY MIX COMPOSITIONS INCLUDING CORN SYRUP AND METHODS OF PREPARING BAKED GOODS SUCH AS CAKES AND MUFFINS THEREFROM

(76) Inventors: Robert R. Golaszewski, New Hope, MN (US); Angela M. Horstman, Winsted, MN (US); Sarah Meacham, Lakeville, MN (US); Elizabeth A. Melcher, Shoreview, MN (US); Alyssa L. Randall, Plymouth, MN (US); Chad Martin Rieschl, Brooklyn Park, MN (US)

Correspondence Address: GENERAL MILLS, INC., P.O. BOX 1113, MINNEAPOLIS, MN, 55440, US

(21) Appl. No.: 11/559,920

(22) Filed: Nov. 15, 2006

Related U.S. Application Data
(60) Provisional application No. 60/737,074, filed on Nov. 15, 2005.

(51) Int. Cl. A21D 10/00

(52) U.S. Cl. 426/549

(57) ABSTRACT

The invention provides shelf stable dry mix compositions for use in preparing a baked good, the dry mix compositions including flour, sweetening agent, wherein a portion of the sweetening agent is liquid corn syrup, and fat source. Optionally, the dry mix compositions include leavening systems. Methods of making shelf stable dry mixes are also described.

### CROSS-REFERENCE TO RELATED APPLICATION

This application claims the benefit of priority under 35 U.S.C. 119(e)(1) of a provisional patent application Ser. No. 60/737,440, filed Nov. 15, 2005, which is incorporated herein by reference in its entity.

### FIELD OF THE INVENTION

The invention relates to food products in the form dry mix compositions containing liquid corn syrup, especially for leavened baked goods. The invention further relates to methods of making such dry mix compositions, as well as to baked goods made from such dry mix compositions.

### BACKGROUND OF THE INVENTION

Dry mixes for preparation of food products are widely used. Such dry mixes are commonly sold commercially to consumers or commercial bakers. Typically, the consumer or baker adds ingredients such as water, milk, eggs, oil, shortening, butter or margarine, and the like to the dry mix to prepare a batter or dough. The batter or dough is then baked to form finished goods (for example, layer cakes, specialty cakes, muffins, biscuits, pancakes and quick breads).

Dry mixes for preparing baked goods typically include sweetener, flour, shortening, and a variety of other constituents that depend upon the final desired baked good. The sweetener typically consists of sucrose or low calorie sweeteners.

### SUMMARY OF THE INVENTION

Generally, the invention provides dry mix compositions comprising a sweetening agent, flour, and a fat component. The dry mix compositions are useful for preparing baked goods, especially sweet goods, such as cakes (including specialty cakes, coffee cakes, quickbreads, angelfood cakes, funnel cakes and the like), muffins, biscuits and the like. Optionally, when the dry mix is utilized to prepare a leavened baked good, such as cakes, muffins, and the like, the dry mix compositions can further include a leavening system. As a result of the dry nature of the ingredients of the mixtures, they are typically shelf-stable at ambient conditions for many months.

The inventive dry mix compositions include liquid corn syrup as a substitute for at least a portion of the sweetening agent. In certain embodiments, use of liquid corn syrup in dry mix compositions has provided the ability to reduce the total amount of sweetening agent included in dry mix compositions, thereby providing a reduced sweetening agent-to-flour (sweetening agent:flour) ratio in dry mixes. In some embodiments, significant cost savings can be realized by using relatively lower cost of corn syrup in substitution for typical sucrose used in dry mixes even when used at equivalent solids levels. In some embodiments, the inventive dry mix compositions have also resulted in reduced bake times when the dry mixes are utilized to prepare batters that are in turn baked to provide finished baked goods. Reduced bake time can be particularly advantageous for commercial bakers.

Liquid corn syrup typically has a moisture content in the range of about 16% to about 29%. Given this high moisture content, it is unlikely that one would consider adding this type of ingredient to an otherwise “dry” mix. Consumer expectations of a dry mix composition generally include a free-flowing, particulate mix that does not have large clumps of components. The components of dry mixes are typically dry or have very low moisture content in themselves (for example, sugar, flour and shortening). Thus, one could anticipate that adding a liquid component to other “dry” ingredients would be likely to cause clumping of the ingredients of the dry mix composition. Such clumping could then potentially shut down the processing equipment and/or require additional processing to break up the clumps. Additional processing steps could involve drying the components after addition of the liquid corn syrup and/or granulating the components to achieve the free-flowing character expected of a dry mix composition. Any of these additional, separate processing steps would increase capital equipment and energy costs.

However, the inventive methods and compositions include a liquid corn syrup component in dry mix compositions. Surprising features of the invention can be seen in processing aspects and compositional aspects. For example, some processing features of the invention include the ability to include a liquid component in an otherwise dry mix operation, without causing undesirable clumping of the ingredients and/or shutting down of processing equipment. This can be achieved, in some embodiments, by one or more of the following: controlling the addition sequence of the components of the dry mix, controlling temperatures of one or more components of the dry mix, and/or adding the components with mixing. In other processing aspects, the liquid corn syrup can be added to conventional dry mix compositions without requiring additional processing steps such as drying or granulating. In compositional aspects, the inventive dry mixes are relatively dry, free-flowing compositions that can be packaged and used in the same manner as conventional dry mixes.

In some article aspects, the invention provides a packaged, shelf-stable dry mix composition that is useful for preparing baked goods. Typically, the packaged product is provided in an air-tight pouch or other suitable container.

Thus, in some aspects, the invention provides shelf stable dry mix compositions for use in preparing a baked good, the dry mix comprising: (a) flour; (b) sweetening agent, the sweetening agent comprising liquid corn syrup and a sweetener; and (c) fat source, wherein the liquid corn syrup has a moisture content in the range of 16% to 29%, and wherein the liquid corn syrup is present in an amount of 10% or less by weight, based on weight of the dry mix composition.

In some aspects, the invention further provides baked products that are prepared from the dry mix compositions. According to these aspects, the baked products possess similar moisture, bake height, and mouthfeel properties as compared to baked products produced from conventional dry mixes. The dry mix compositions can provide desirable baked products that are similar to those prepared either from scratch from conventional batters or from dry mixes containing conventional nutritive carbohydrate sweeteners (such as sucrose).

The inventive dry mix compositions can be utilized to prepare a variety of baked goods, including, for example, cakes (including specialty cakes, coffee cakes, quickbreads, angelfood cakes, funnel cakes and the like), muffins, biscuits, pancakes and the like. In these aspects, the dry mix compositions can further include a chemical leavening system. In other aspects, the dry mix compositions can be utilized to prepare unleavened baked goods.

In some method aspects, the invention provides methods for making shelf stable dry mix compositions useful for preparing baked goods, the methods comprising steps of:

(a) providing a dry preblend comprising flour and sugar;

(b) providing liquid corn syrup to the dry preblend, the liquid corn syrup having a moisture content upon addition to the dry preblend in the range of 16% to 29%, wherein the liquid corn syrup is provided in an amount of 10% or less, based upon total weight of the dry mix composition;

(c) providing a fat component (the fat component typically including emulsifier) to the dry preblend; and

(d) mixing the flour, sugar, liquid corn syrup and fat component to provide a dry mix composition.

The resulting dry mix compositions typically have a moisture content of 15% or less, or more commonly 5.5% or less based on total dry mix weight.

For purposes of illustration, use of the inventive compositions and methods to prepare dry mixes useful for preparing cakes will be described in detail. Dry cake mixes have been selected because these baked goods are typically prepared from dry mixes or from scratch; thus, the advantages resulting from the invention can be easily illustrated. Moreover, consumers have certain expectations of cake products, such as tender, moist product texture and acceptable baked height. Thus, these systems provide the ability to describe the desirable organoleptic properties of baked goods prepared from the inventive dry mix compositions and systems.

These and other aspects and advantages will now be described in more detail.

### DETAILED DESCRIPTION OF THE INVENTION

The embodiments of the invention described below are not intended to be exhaustive or to limit the invention to the precise forms disclosed in the following detailed description. Rather, the embodiments are chosen and described so that others skilled in the art can appreciate and understand the principles and practices of the invention.

Throughout the specification and claims, percentages are by weight and temperatures in degrees Fahrenheit unless otherwise indicated. Moreover, when ranges are described as including an amount “up to” a certain value, the range is intended to include amounts up to and including the specified value (e.g., when referring to an amount up to 36 months, the range is intended to encompass time periods up to and including 36 months). All referenced patents and patent applications, if any, are hereby incorporated by reference.

As described herein, “ambient” temperatures generally refer to temperatures in the range of about 65° F. to about 85° F. (about 18° C. to about 30° C.).

As described herein, “shelf stable” means a composition that is formulated to be stored at ambient temperatures for periods of time of up to six months, or up to 12 months, or up to 36 months, without product spoilage. Further, it will be apparent from review of this disclosure that these shelf life values can be extended if modified atmospheric packaging (MAP) is utilized in conjunction with the inventive dry mixes (such as gas-treatment or vacuum packaging techniques).

In some aspects, the invention provides dry mix compositions that are useful for preparing a variety of baked goods. As used herein, the term “dry mix” is considered to comprise a mixture that includes flour, sweetening agent, and a fat component that is in a relatively dry, flowable form and is adapted to be mixed with one or more additional ingredients for baking to produce an edible baked good. The dry mix compositions are provided in a flowable form, for example, being in a suitably free-flowing, particulate form that allows the compositions to be combined with other ingredients (such as liquid ingredients) to produce a batter or dough, which is in turn used to prepare a final baked good. The precise particle size of the dry mix composition is not critical, so long as the dry mix composition is suitably combinable with other ingredients to produce a batter or dough, as discussed herein. The relative proportions of these ingredients can be adjusted as desired and the mix can include any other ingredients necessary for the particular desired baked good, such as salt, cocoa or the like. It will be appreciated that recipes for a wide variety of baked goods are well known in the art and need not be set forth in detail herein.

Reference herein to “preblends” or “preblended” components or ingredients refers simply to a mixture of the specified components. The preblend can be formed at any time during the formulation of the dry mix components by combining the ingredients of the preblend. In accordance with the invention, reference to preblended components simply refers to the fact that the components are combined before additional ingredients thereafter specified are added. For example, when reference is made to a dry preblend of flour and sugar, and addition of liquid corn syrup is described as being provided to the dry preblend, it is contemplated that the flour and sugar are combined prior to addition of the liquid corn syrup. However, use of the terms “preblend” or “preblended” is not meant to require that the components of the preblend be mixed to any particular degree or at any particular time other than as described in this paragraph.

The term “smizing” as used herein refers to submitting the ingredients to high shear conditions, for example, using a turbilizer and/or finisher. Typically, smizing is performed within existing mixing equipment, as part of the mixing steps (as opposed to a separate unit operation). Smizing is well known in the dry mix art and the skilled artisan will have no difficulty in selecting useful equipment to practice such a step or operation.

The inventive dry mix compositions generally comprise at least flour, sweetening agent, and a fat component. Each of these components will now be described.

Flour

According to the invention, the dry mix compositions include a grain constituent that contributes to the structure of the baked good prepared from the dry mix composition. A variety of different flours can be used as the grain constituent, and different flours can be selected to give a variety of textures, tastes, and appearances to the final baked product.

Useful flours include, but are not limited to, hard wheat flour, soft wheat flour, corn flour, high amylose flour, rice flour, low amylose flour, oat flour, or combinations of any two or more of these. The relative proportions of the types of flours used can be varied as desired.

When preparing dry mix compositions for cake applications, wheat flours can be particularly advantageous. Any type of wheat flour can be utilized in accordance with the invention, and selection of the particular wheat flour can depend upon the baked good to be prepared from the dry mix compositions. For preparation of layer cake dry mixes, cake flour can be advantageous. Cake flour generally is characterized by a lower protein content. In the United state, chlorinated cake flour is especially popular to realized dry mixes for layer cakes having high sugar to flour ratio's to provide especially tender and moist finished layer cakes. (For a good description of cake flours but chlorinated and non-chlorinated, see for example, U.S. Pat. No. 5,456,930 “Dielectric Heating Treatment Of Unchlorinated Cake Flour” issued Oct. 10, 1995 to Gusek et al.) While chlorinated cake flours are specifically contemplated for use, also useful herein are a wide variety of flour types typically employed in dry mixes including bleached flours, heat treated flours, all-purpose flours and even bread flours as well as mixtures of such flour types. In certain embodiments, the flour component is processed by milling and fractionation to essentially strip of any protein component and is in the nature of a flour fraction such as a wheat starch.

Also, bleached flours are contemplated for use herein. Also contemplated for use herein are whole grain wheat flours from white wheat including those milled from naturally white varieties (See, for example U.S. Pat. No. 6,372,281 “Process Of Milling Hard White Wheat And Products Thereof” issued Apr. 16, 2002 to Metzger et al.) as well as from bleaching the grain (See, for example U.S. Pat. No. 6,497,909 “Method Of Bleaching Cereal Grain” issued Dec. 24, 2002 to Lloyd Metzger) or the bran portion thereof (See, for example, U.S. Pat. No. 6,899,907 “Bleached Bran And Bran Products And Methods Of Preparation” issued May 31, 2005 to Monsalve-Gonzalez et al.). Also contemplated are those whole grain durum flours that are described in commonly assigned co-pending U.S. Ser. No. 11/212,860 “Whole Grain Products Made With Whole Grain Durum Wheat” filed 26 Aug. 2005 by Mingus et al. or in U.S. Ser. No. 11/364,561 “Whole Grain Products Made With Whole Grain Durum Wheat” filed Aug. 26, 2005 by Mingus et al.

The dry mix compositions typically include an amount of flour effective to provide structure to a baked good prepared from the dry mix composition. The amount of flour included in the dry mix compositions can be described with reference to a batter prepared from the dry mix compositions. Generally speaking, the amount of flour should not be so high that a batter prepared from the dry mix is dry and loses its ability to expand. However, the amount of flour should not be so low that a batter prepared from the dry mix composition is unsuitably soft and loses its structure during baking. The inventive dry mix compositions generally contain flour in the range of about 10 to about 90%, or in the range of about 30 to about 60%, based upon total dry mix weight.

Conventionally, flour is standardized to about 14% moisture. Short patent cake flour can be provided with a lower moisture content, for example, 5-12% moisture. In some aspects of the invention, the flour can be treated to further reduce the moisture content prior to combining the flour with other ingredients in the dry mix composition. For example, it has been found useful, in some embodiments for preparation of cake dry mix compositions, to dry flour down to a moisture level in the range of about 5% to about 12%, or about 7% to about 11%, or about 8% to about 10%. As discussed elsewhere herein, moisture management within the dry mix composition can be important to provide one or more features of the inventive compositions.

One way to characterize flour is by the protein content. Useful flour(s) can be of conventional type and quality, including cake flour, bread flour, and all-purpose flour, as described herein. As mentioned previously, wheat flour can be useful. In some aspects, other flours conventionally used in the preparation of baked goods can be employed in full or partial substitution of the wheat flour. Traditional cake flour used for layer cakes has about 8% or less protein by weight of the flour. Pastry flour ordinarily has a protein level of about 10%. Other flours such as bread flour generally have higher protein levels in the range of about 11% to about 13% by weight. Optionally, flours can be supplemented with a protein supplement such as gluten, for example, when the protein content of the flour is lower than desired. The use of a protein supplement will often be determined based upon the desired total protein content of the dry mix composition.

In some embodiments, the wheat flour useful to make the inventive dry mix compositions has a protein content in the range of about 7% to about 10% by weight of the flour. All-purpose flour can also be used. Such all-purpose flour generally comprises a mixture of both hard and soft wheat flours (both high protein level and low protein level flours). Such flours are useful if the average protein content is in the range of about 7% to about 10% by weight.

Both chlorinated and unchlorinated flours can be used in accordance with the invention. Selection of chlorinated and/or unchlorinated can depend upon the final application of the dry mix composition. In some aspects, malted flours that are typically used for bread making are avoided. Enzyme inactivated flours can also be utilized. Enriched flours can also be utilized.

Sweetening Agent

According to the invention, a sweetening agent or blend is included in the inventive dry mix compositions. The sweetening agent comprises liquid corn syrup and a second supplemental sweetener. The second supplemental sweetener typically comprises sucrose and/or other common nutritive carbohydrate sweetener ingredients, such as sweeteners conventionally used for dry mix compositions. Generally, the sweetening agent can act as a sweetener and bulking agent providing improved taste and higher moisture mouthfeel in the final baked product.

The inventive dry mix compositions can include two or more sweeteners; thus, reference to the singular form will be understood to include situations where more than one type of sweetener is included in the inventive compositions.

Useful liquid corn syrup has a dextrose equivalent (DE) of 20 or more. Illustrative liquid corn syrup has a DE in the range of 20 to 97. In some aspects, the liquid corn syrup has a DE of about 63 to 65. High fructose liquid corn syrups can also be utilized, such as syrups having a fructose content in the range of 42-90.

According to the invention, useful liquid corn syrup has a moisture content in the range of about 16% to about 29%, or in the range of about 18-23%. The moisture content of liquid corn syrup is significantly higher than other conventional “dry” sweeteners. For example, sucrose (table sugar) typically has a moisture content of about 0.5% or less. Corn syrup solids typically have a maximum moisture content of about 7%, while crystalline fructose typically has a maximum moisture content of 0.5%. As discussed herein, inclusion of an ingredient with such high moisture levels in a dry mix composition is technically surprising and can provide unexpected benefits to batters or doughs, as well as final baked goods, prepared from such dry mix compositions.

According to the invention, the remainder of the sweetening agent comprises sugar or other nutritive carbohydrate sweetener ingredient. Useful sugars include saccharides that can reduce the amount of free water in the composition. Useful sugars include monosaccharides, disaccharides, polysaccharides, and their various degradation products. Illustrative sugars include, but are not limited to, pentoses, xylose, arabinose, glucose, galactose, mannose, amylose, fructose, sorbose, lactose, maltose, dextrose, sucrose, maltodextrins, molasses and brown sugar. In some embodiments, the sugar is selected from dextrose, sucrose, and maltodextrin. Commercially available powdered sugar typically contains up to about 4% starch as an aid to maintaining its free-flowing properties. The granulation of the second sweetener can be range from coarse to double or even tripled milled to powdered sugar.

Because the sweetening agent imparts sweetness to the baked product, the kind and amount of sweetener(s) and liquid corn syrup are selected to achieve a desired degree and quality of sweetness in a final baked product prepared from the dry mix, while providing a suitable moist mouthfeel of the baked product. This can be achieved by balancing both the ratios of various components of the sweetening agent to one another and the ratios of sweeteners or liquid corn syrup to flour in the dry mix composition.

Within the total sweetening agent, the ratio of liquid corn syrup to the sweetener (such as sugar) can be selected to provide the desired sweetness and mouthfeel of a baked product. Using sucrose as an example, the ratio of sucrose to liquid corn syrup (sucrose:liquid corn syrup) can be in the range of 1:1 to 100:1, or 7:1 to 12:1. Put another way, liquid corn syrup can comprise up to 100% of the sweetening agent, or about 7% to about 12% of the sweetening agent. When the sweetener comprises a different nutritive carbohydrate sweetener ingredient (such as dextrose, maltodextrin, brown sugar, or the like), the ratio of such sweetener ingredient to liquid corn syrup can be adjusted, using the description herein and without undue experimentation.

A useful total amount of sweetening agent in a dry mix composition of the present invention includes an amount that provides suitable properties such as sweetness to a finished product prepared from the dry mix, and/or a desired moisture content to the dry mix. When reference is made herein to the total amount of sweetening agent, such amount includes sweetening agent from all sources (for example, liquid corn syrup as well as sugar).

The total amount of sweetening agent is selected to achieve a desired ratio of sweetening agent to flour ratio (sweetening agent:flour). For example, if too much sweetening agent is added to the dry mix, this can result in an insufficient amount of flour being present in the dry mix. Thus, a baked good prepared from a composition with too much sweetening agent can collapse upon baking. In contrast, too little sweetening agent in the dry mix composition can result in a baked good that has poor organoleptic properties because there is not enough sweetening agent in the dry mix composition. Further, the baked product can have a dry mouthfeel because there is an insufficient amount of sweetening agent in the composition to provide the tender or moist mouthfeel.

The particular sweetening agent:flour ratio can depend upon such factors as, for example, the particular sweetener(s) and liquid corn syrup employed, the final food product, desired baked good attributes, and the like. Useful sweetening agent:flour ratios are in the range of 0.1:1.0 to 2.0:1.0, or in the range of 0.7:1.0 to 1.3:1.0.

Such a total amount of sweetening agent can be in the range of about 1% to about 80% by weight of the dry mix composition, or in the range of about 20% to about 60% by weight, the weight percentages based upon the total weight of the dry mix composition. In accordance with the invention, liquid corn syrup can be present in an amount up to about 10% of the dry mix compositions. In some embodiments, liquid corn syrup is present in an amount of about 1% to about 10%, or about 2% to about 8%, or about 3% to about 6% of the dry mix compositions (percentages being weight percent, based upon total weight of the dry mix composition).

It will be readily appreciated upon review of this disclosure that substitution of at least a portion of the sweetening agent with liquid corn syrup will correspondingly reduce the amount of sugar included in the dry mix compositions. This reduction in the amount of sugar is illustrated in the non-limiting examples, as the reduced sugar:flour ratio of the dry mix compositions. Such reduction in sugar can provide several benefits, as discussed herein.

Moreover, the use of liquid corn syrup has surprisingly provided the ability, in some embodiments, to reduce the total amount of sweetening agent in the dry mix compositions, while still delivering acceptable organoleptic properties, such as tenderness, moistness, and sweetness. This feature of the invention is also illustrated in embodiments described in the non-limiting examples.

The sweetening agent is selected to provide desired humectant properties to the dry mix compositions. As discussed, liquid corn syrup will retain moisture within the dry mix composition. The sweetener included with the liquid corn syrup to provide the overall sweetening agent can be selected to complement the moisture-binding features of the liquid corn syrup. The sweetener can be selected based upon application of the dry mix (in other words, the type of baked good to be prepared from the dry mix composition).

The skilled artisan will appreciate that the present invention finds particular suitability for use in the United States due to price controls on sucrose in order to support domestic producers of sucrose at the expense of consumers. Also, importation of sucrose is strictly controlled. In the US, the commodity price for bulk sugar is typically maintained at 2-5 times that of the world price for sugar. As an example, the world commodity price for sugar at present is about $US0.05/pound (5¢/lbs.) while the US sugar price is currently $US0.20/pound (20¢/lbs.). Consequently, for those dry mixes formulated and made in the US, there is intense interest in using substitute sweeteners such as corn syrups that are non price controlled and thus are less expensive than price controlled sucrose. Thus, the motivation for the present invention is particularly resident in the United States.

In some embodiments, at least a portion of the sweetening agent can be substituted with a high potency heat tolerant sweetener. In some aspects, inclusion of the high potency sweetener can provide additional sweetness to the final baked product. In some aspects of the invention, a high potency sweetener is a component that provides a sweet taste to the final product, where the component contributes no calories or where the component does contribute calories, but possesses a sweetness potency that is so high that their extremely low usage level imparts no significant impact on the final product's caloric content. In some embodiments, the high potency sweetener is selected so as not to degrade during either storage or more importantly, during the baking step. While degradation during storage and baking can be overcome by over fortifying with a high potency sweetener to compensate for the expected loss, such extra addition is costly. Illustrative high potency heat tolerant sweetener include sucralose and potassium acetysulfame and mixtures thereof. Other illustrative high potency sweeteners include polydextrose, aspartame, potassium acetylsulfame, saccharine, cyclamate, neotame, alitame, and combinations of any two or more of these. Sugar alcohols that can be utilized include isomalt, lactitol, maltitol, mannitol, sorbitol, erythritol, xylitol, glycerol/glycerin, and combinations of any two or more of these.

When the inventive compositions include one or more high potency sweeteners, the total amount of sweetening agent included in the composition is typically decreased. Thus, in embodiments where the compositions include high potency sweetener, the sweetening agent can comprise up to 40% of the total dry mix composition, or in the range of about 0.01% to about 40% of the dry mix composition. As a result, one of skill in the art will readily appreciate that bulking agents can be included to compensate for lost weight within the overall composition. Suitable bulking agents include any inert ingredients that do not impact overall textural qualities of the baked product. Illustrative bulking agents include crude fiber that can be composed of cellulose, hemicellulose, lignin, and pectin substances; starches, flour, whey, maltodextrin and the like.

Fat Component

The inventive dry mix compositions can include an edible fat component. A fat component can add richness to the eating properties of the finished baked goods. A fat component can also impact characteristics of batters prepared from the dry mixes, as well as characteristics of the final baked good (such as texture). The fat component can have beneficial effects on the volume, grain, and texture of the final product, as well as the texture, mouthfeel and/or other organoleptic properties of the baked good. The fat component can be added in any suitable form, such as dried, plasticized or liquid.

Useful fat components include shortenings and oils. Animal or vegetable based natural shortenings can be used, as can synthetic shortenings or oils.

Typical shortenings include fatty glyceridic materials that can be classified on the basis of their physical state at room temperature. Solid shortenings are useful and can provide the advantage of desirable mouthfeel upon consumption. In some embodiments, mixtures of liquid and solid shortenings can be utilized. Such mixes can be fluid or plastic, depending in part upon the level of solid fatty materials.

The solid fatty glycerides can include fatty mono-glycerides and diglycerides of saturated fatty acids having 4 to 22 carbon atoms. The liquid shortening can be animal, vegetable or synthetic oil (such as sucrose polyesters) that is liquid at ordinary room temperatures. Representative of such typical fat sources are palm oil, butter or margarine, lard, tallow, coconut oil, palm kernel oil, cottonseed oil, peanut oil, olive oil, sunflower seed oil, sesame seed oil, corn oil, safflower oil, poppy seed oil, soybean oil, canola (rapeseed) oil, babassue oil, and the like and combinations thereof. Other suitable shortening materials and methods of shortening preparation are described in detail in Bailey, “Industrial Oil and Fat Products,” (3^{rd} ed. 1964).

Mixtures of the oils described herein can also be used, as can solid fatty materials, such as saturated triglyceride fats. In general, such solid fatty materials can be added to liquid oil, in an amount in the range of about 1.5% to about 25% of triglycerides that are solid at 70° F. (21.1° C.).

A useful amount of total edible fat component in a dry mix composition of the present invention (from all sources) includes an amount that provides suitable properties such as organoleptic qualities and desired textural properties to the finished baked good. Such an amount can be up to about 30% of the dry mix composition, or in the range of about 1% to about 10% by weight. For preparation of a lower fat baked good, the dry mix compositions can include total fat in an amount up to about 10% or in the range of about 1% to about 5% by weight, based upon the total weight of the dry mix composition.

Historically, in the United States, hydrogenated oils especially hydrogenated soybean oil, has been the fat ingredient of choice for use in formulating dry mixes intended for room temperature storage for consumer packaged food products. Hydrogenated oils have been preferred due in part to their physical and chemical stability as well as their wide availability at low cost. In Europe and elsewhere where hydrogenated oils are generally not permitted, naturally stable (both physically and chemically) fat materials have been preferred, especially tropical oil ingredients, principally palm oil. Recent health trends in the US include attention towards reducing Tran's fatty acids levels that are typically an impurity or by-product of many hydrogenated oils. Consequently, at present, in the US increased attention is being made to blends of palm oil and other oils for use in all manner of consumer food product applications.

Optionally, the inventive dry mix compositions can include a fat-replacer, for instance, when it is desired to provide a baked product having less fat, or even being fat-free. Suitable fat-replacers can be selected to mimic the effects of the fat component in the dry mix composition, for example, by binding water present in the dry mix composition and/or providing fat-like sensory properties in the baked products. The fat-replacer can improve softness, texture, and/or mouthfeel of baked products prepared from dry mix compositions containing the replacer.

One type of fat-replacer suitable in accordance with the invention is fiber. Any suitable fiber obtained from a plant source can be utilized in accordance with the invention. An illustrative fiber is citrus fiber. A commercially available citrus fiber that can be useful is Citri-Fi™ (Fiberstar, Inc., Willmar, Minn.).

Leavening System

In some embodiments, the inventive dry mix compositions can optionally include chemical leavening systems. Chemically-leavenable (“chemically-leavened”) dry mix compositions are dry mix compositions formulated to provide batters or doughs (when combined with additional ingredients) that leaven to a substantial extent by the action of chemical ingredients that react to produce a leavening gas. Typically, the ingredients of a chemical leavening system include a basic chemical leavening agent and an acidic chemical leavening agent that react together to produce carbon dioxide, which, when retained by a batter matrix, causes the batter to expand. Chemically-leavenable batters or dough compositions can be contrasted to batter or dough formulations that are substantially leavened due to the action of yeast as a leavening agent, that is, by metabolic action of yeast on a substrate to produce carbon dioxide.

Basic chemical leavening agents are generally known in the baking arts and any chemical leavening base that is capable of undergoing a reaction with a chemical leavening acid is suitable for use in dry mix compositions of the invention. A basic agent may be encapsulated or non-encapsulated. Both encapsulated and non-encapsulated basic chemical leavening agents are generally known and commercially available, and can be prepared by methods known in the baking and encapsulation arts.

As a result, only the exemplary chemical leavening bases, namely sodium bicarbonate (baking soda), ammonium carbonate, ammonium bicarbonate, and potassium bicarbonate, is recited herein. In some aspects, baking soda can serve as the primary source of carbon dioxide gas in many chemical leavening systems.

Acidic chemical leavening agents are generally known in the baking arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), dicalcium phosphate (DCP), sodium aluminum sulfate (SAS), glucono-delta-lactone (GDL), potassium hydrogen tartrate (cream of tartar) as well as a variety of others, and combinations of any of these. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP). Acidic chemical leavening agents come in a variety of solubilities at different temperature ranges, and may be either encapsulated or non-encapsulated. An illustrative leavening system includes sodium aluminum phosphate and baking soda.

The chemical leavening agents can be present in an amount that provides one or more useful properties as described herein, including stability at ambient temperatures/conditions, and desired baked leavening properties following storage at ambient conditions. For example, the leavening system can make up about 5% by weight of the dry mix composition, or in the range of about 1% to about 3% by weight of the dry mix composition, and the ratio of leavening acid to leavening base can be in the range of about 1:1 to about 1.5:1.

Emulsifier

In some aspects, the inventive dry mix compositions can include an emulsifier component. The emulsifier component can include one or more emulsifiers. Emulsifiers can be nonionic, anionic, and/or cationic surfactants that can influence the texture and homogeneity of batters produced from the dry mix compositions, and/or improve eating quality of a finished product. Such emulsifiers can aid the realization of baked goods with improved grain structure and texture by aiding in air incorporation and foam stabilization of the batter.

Generally useful as emulsifiers are partially esterified polyhydric compounds having surface-active properties. This class of emulsifiers includes among others, mono- and diglycerides of fatty acids, such as monopalmitin, monostearin, monoolein, and dipalmitin; partial fatty esters of glycols, such as propylene glycol monostearate and monobehenate; glyceryl-lacto esters of fatty acids; ethoxylated mono- and diglycerides; higher fatty acid esters of sugars, such as the partial palmitic and oleic acid esters of sucrose; and phosphoric and sulfuric acid esters, such as dodecyl-glyceryl ether sulfate and monostearin phosphate. Other examples include the partial esters of hydroxycarboxylic acids, such as lactic, citric, and tartaric acids with polyhydric compounds, for example, glycerol lacto-palmitate, and the polyoxyethylene ethers of fatty esters of polyhydric alcohols, such as a polyoxyethylene ether of sorbitan monostearate or distearate. Fatty acids alone or esterified with a hydroxy carboxylic acid, for example stearoyl-2-lactylate, are also useful.

The total amount of the emulsifier component in the dry mix compositions can be adjusted such that suitable organoleptic properties are obtained. In some aspects, the emulsifier component can be present in an amount up to about 10%, or in the range of about 0.1% to about 10% by weight, or about 0.1% to about 4% by weight, based on total weight of the dry mix.

In other aspects, the total level of emulsifiers in the dry mix compositions can be adjusted such that the final baked goods prepared from the inventive dry mix compositions have a rich mouthfeel, a tender texture and a baked specific gravity as described herein. Some illustrative baked specific gravity values include about 0.2 g/cc to about 0.4 g/cc (for pancakes); about 0.5 g/cc to about 1.1 g/cc (for cakes); and other appropriate values based upon the final baked good to be prepared. All or a portion of the emulsifier can be blended into the fat ingredient. All or a portion of the emulsifier can be added “over-the-side”, i.e., directly into the dry mix rather than being pre-mixed with the fat or shortening component.

In accordance with the invention, one or more optional components can be included in the dry mix compositions. Some illustrative optional components will now be described.

Optionally, the inventive dry mix compositions can include a variety of additional minor ingredients or “conventional additives” suitable for rendering finished baked goods prepared therefrom more organoleptically desirable. Such optional dry mix components can modify any number of organoleptic, nutritional, flavors, color, or other properties of a baked good prepared from the dry mixes of the invention. In particular, the compositions can additionally include cocoa, spices, salt, flavors, vitamins, minerals, particulates (such as fruits, nuts, candies, chocolates, compound pieces chocolate bits and the like), starches, gums, colorings, lecithin, food acids, anti-oxidants, and the like at conventional levels. If present, such optional components collectively comprise about 1% to about 35% of the dry mix composition. Especially preferred for use herein is an added salt component.

Optionally, the inventive dry mix compositions can further include an anti-mycotic agent to enhance microbial stability. Useful anti-mycotic agents include sorbic acid and its derivatives such as sodium or potassium sorbate, propionic acid and its derivatives, vinegar, sodium diacetate, monocalcium phosphate, lactic acid, citric acid, and the like. These agents can be present in an amount to aid in the inhibition of growth of undesirable yeast and/or molds, typically in a range of about 0.01% to about 1% on a dry weight basis of the dry mix composition.

In some embodiments, the dry mix compositions can include a hydrophilic colloid (also referred to as hydrocolloids). Illustrative hydrophilic colloids include carboxymethyl cellulose, micro-crystalline cellulose, dextrin, gellan, guar, karaya, locust bean, xanthan, and the like, as well as mixtures thereof. When present, the hydrocolloid can be present in an amount in the range of, for example, about 0.05% to about 1.5%, or about 0.05% to about 0.5%.

Optionally, the dry mix compositions can further include a starch component. Starch addition can be used to influence a variety of product attributes such as viscosity, and volume and texture of the finished (baked) good. The starch used can be any of the common food starches, for example, potato starch, corn starch, wheat starch, rice starch, barley starch, oat starch, tapioca starch, arrowroot, and sago starch. Modified starches and pregelatinized starches can also be used. If present, the added starch ingredient(s) can comprise about 0.1% to about 10%, or about 0.5% to about 5%, or about 0.5% to about 2% of the dry mix compositions (dry weight basis).

Another optional ingredient is nonfat dry milk solid. Nonfat dry milk solids can aid the structuring of finished baked goods. If present, such dry milk solids can comprise up to about 4%, or about 0.5% to about 3% (dry weight basis) of the dry mix compositions. In some embodiments, various milk fractions such as whey or whey proteins can be added along with the nonfat dry milk solids.

Dry Mix Compositions

In some aspects, the inventive dry mix compositions have total moisture content in the range of about 15% or less, or about 6.0% or less, or in the range of about 2% to about 5.5% for acceptable shelf-stability and baked product quality. The total moisture content includes water provided with or associated with the various essential and optional ingredients of the dry mix compositions. For example, total moisture can include the moisture associated with flour, liquid corn syrup, starch, cocoa and the like. The total moisture can be easily determined by vacuum oven drying of the dry mix compositions herein. In some aspects, the dry mix compositions exhibit a water activity of 0.6 or less, which can suppress microbial activity for the desired shelf life of the compositions.

It has been found that management of moisture within the dry mix compositions can be important to providing suitable compositions for preparation of baked goods. Liquid corn syrup typically has a moisture content in the range of about 16% to about 29%. Generally, the added moisture contributed by the liquid corn syrup can be controlled within the dry mix composition by controlling moisture content of the flour component (as described herein) or other moisture containing dry ingredients. In accordance with the invention, a dry mix composition can be provided that remains flowable, yet has been formulated with a liquid component that has a higher moisture content than ingredients conventionally included in dry mix compositions. The total moisture content of the dry mix compositions is controlled by selection of types and amounts of the various ingredients described herein, to provide dry mix compositions with overall moisture contents of 10% or less. Thus, in some aspects, the invention provide methods for formulating dry mix compositions comprising selecting a liquid corn syrup as a portion of a sweetening agent, and selecting the remaining components of the dry mix composition (for example, flour, starch, cocoa and the like) to achieve an overall moisture content of the dry mix in the range of 10% or less.

Not intending to be bound by a particular theory, the type of sugar utilized in accordance with the invention can impact the overall baking time. Sucrose, for example, easily binds free water in the mixture. Higher sucrose levels in a dry mix formulation will cause a longer baking time, by delaying the onset of starch gelatinization and prolonging the time interval for cake or other baked good expansion. Use of liquid corn syrup as a partial replacement for sucrose can also impact baking time. The monosaccharide component of liquid corn syrups, glucose, maltose, and fructose is less able than sucrose to bind available water. By replacing dry sugar with liquid corn syrup, less of the available water is bound by the sucrose, and thus, the water bound by glucose is released more quickly and easily during baking, providing quicker gelatinization of starch and ultimately, a shorter baking time.

Formulation

Dry mix compositions of the invention can generally be prepared by combining flour, sugar, and minor ingredients with mixing for a time sufficient to blend the ingredients. Corn syrup is heated to a temperature (for example, in the range of 80-140° F.) prior to combining with the blended composition. After corn syrup addition is completed, addition of the fat source (the fat source typically including emulsifier) is made, and then the mixture is smized to a desired particle size. Target lump count is measured on a U.S. Standard No. 20 Sieve and is 0-5%. The corn syrup, emulsifiers and fat component can be combined concurrently or separately during mixing.

One illustrative formulation for dry mix compositions is as follows:

| Ingredient | Useful ranges (weight percent) |
|---|---|
| Flour | 10-60 |
| Sweetening agent | 1-80 |
| Fat and emulsifier | 1-40 |
| Leavening system | 0-5 |
| Gums | 0-2 |
| Starch | 0-10 |
| Minor ingredients | 0-10 |
| Cocoa | 0-10 |

The weight percentages for the formulations are calculated on a dry weight basis and do not include any added water in the formulation. The weight percentages of flour and sugar are calculated from the weight of the solids in the dry mix composition.

In some aspects, the invention provides methods of formulating a dry mix composition, the method including steps of providing a dry preblend comprising flour and sugar; providing liquid corn syrup to the dry preblend, the liquid corn syrup having a moisture content upon addition to the dry preblend in the range of 16% to 29%; providing a fat/emulsifier component to the dry preblend; and mixing the flour, sugar, liquid corn syrup and fat component to provide a dry mix composition. Without intending to be bound by a particular theory, it is believed that the liquid corn syrup can be included in a dry mix composition while retaining features expected of dry mix compositions (such as a free-flowing, particulate nature), by one or more of the following: controlling the addition sequence of the components of the dry mix, controlling temperatures of one or more components of the dry mix, and/or adding the components with mixing. In some embodiments, the liquid corn syrup is added to a dry preblend comprising flour and sugar. Subsequent to addition of the liquid corn syrup, fat (and emulsifiers) can be added to the composition. In some embodiments, the temperature of individual components of the composition can be controlled during the formulation process. More particularly, in some aspects, the liquid corn syrup can be provided at a target temperature during addition to the components of the composition. Such target temperature can represent an elevated temperature, for example, in the range of 80° F. to 140° F. In some embodiments, mixing is performed during the addition step of one or more components of the composition. More particularly, in some embodiments, mixing is performed during addition of the liquid corn syrup. In some method aspects, the invention provides methods of making dry mix compositions including liquid corn syrup that do not require additional processing steps such as drying or granulating.

Packaging and Use

Once the dry mix composition has been prepared, it can be further processed according to known methods of packaging for storage at ambient temperatures/conditions. In some embodiments, the dry mix compositions are stored in pouches or other containers that are substantially impervious to air and moisture. The inventive dry mix compositions are shelf stable products that can be stored at ambient temperatures for extended periods of time, such as up to 6 months, or up to 12 months, or up to 36 months (or longer).

The dry mixes can be combined with additional ingredients (including liquid ingredients) by the user and formed into finished prepared food items.

A baked product prepared from the inventive dry mix compositions can be prepared by several known procedures. In one illustrative method, an oven is heated to a baking temperature (typically about 350° F.). Suitable baking pans are greased with shortening, margarine or butter (optionally, the baking pans are also lightly floured or sprayed with a non-stick cooking spray).

In a separate step, a dry mix of the invention is mixed with liquid ingredients, such as water, milk, oil, butter or margarine and eggs, in a large bowl at low speed until moistened. The baking composition is then beat for a suitable time (typically 1-3 minutes) at medium or high speed, and poured into the prepared baking pans. The pans containing the batter are then placed in the preheated oven for 25 to 35 minutes. The baked product is done when a toothpick inserted in the center comes out clean or the baked good springs back when lightly touched in the center. The baked product is then removed from the oven and permitted to cool in the pan on a cooling rack for a suitable amount of time (typically 10-15 minutes).

In some aspects, the dry mix compositions of the invention can be particularly advantageous. For example, the inventive compositions as described herein can provide reduced bake times for preparing baked goods such as cakes. In some aspects, the organoleptic qualities of the product are at least comparable to conventional baked goods prepared from dry mixes. Moreover, product moistness and baked specific volume are comparable. These advantages can be beneficial for in-home consumers as well as in-house bakeries.

In some method aspects, the invention provides methods of preparing finished baked goods from the inventive dry mix compositions. Conveniently, the inventive dry mix compositions are prepared into finished baked goods by simple addition of liquid ingredients, such as water, milk, oil, butter or margarine and eggs, to form a batter or dough. The batter or dough is then placed in suitable baking conditions to form a finished baked good.

The invention will now be described with reference to the following non-limiting examples.

### EXAMPLES

### Example 1

### Inclusion of Liquid Corn Syrup in Yellow Cake Dry Mix

A dry mix for preparing yellow cake was formulated to include liquid corn syrup in partial substitution for sugar as the sweetening agent. This dry mix including liquid corn syrup was compared with a control yellow cake mix that included traditional sweetening agent (without any corn syrup).

A dry mix in accordance with one embodiment of the invention was prepared (Cake Mix A) and compared with a commercially available yellow cake mix (Cake Mix A1) as summarized in Table 1:

TABLE 1
Yellow cake mix including liquid corn syrup
(Cake Mix A) compared with yellow cake mix containing
conventional sugars (Cake Mix A1).

Amount (weight percent)

| Ingredient | Cake Mix A | Cake Mix A1 |
|---|---|---|
| Sugar | 35 | 48 |
| Corn syrup | 5 | — |
| Flour | 46 | 37.5 |
| Fat source/emulsifiers | 8 | 8 |
| Leavening agents | 2.5 | 2.5 |
| Minors | 3.5 | 4 |
| Total | 100 | 100 |
| Sweetening agent/flour ratio | 0.87 | 1.28 |

For preparation of the dry mixes, the following procedure was followed. Flour, sugar and minor ingredients were combined and blended.

For compositions made according to the invention, liquid corn syrup was heated to a target temperature (80-140° F.) and then injected into the dry mixture. After all liquid corn syrup was delivered to the mix; addition of shortening and emulsifiers to the mixer was commenced. After all shortening and emulsifiers were added, the mixture was smized an additional amount of time to ensure complete combination of the ingredients.

The mixture was sampled for lump count on a U.S. Standard No. 20 Sieve. Lump count target was 0.5% to 5%.

To prepare yellow cakes from the dry mixes, about 517 g of the dry mix was prepared. A quantity of 285 ml of water, 65 g of vegetable oil, and 150 g of eggs were added to make a batter. The batter was mixed to combine ingredients, and the batter was poured into a baking pan. Cakes were baked at 350° F. until toothpick inserted in center came out clean.

The specific gravity of the prepared batters was measured prior to baking. After baking, the cake heights for the baked goods were measured. Results are summarized below:

| | |
|---|---|
| Cake Mix A | Cake Mix A1 |

| Batter specific gravity | 0.7-0.9 | | 0.7-0.9 | |
|---|---|---|---|---|
| Center height | 50-4 | mm | 50-4 | mm |
| Side height | 42-34 | mm | 42-34 | mm |
| Bake Time | 29-34 | minutes | 33-38 | minutes |

The results of this testing showed that dry mixes including liquid corn syrup, in accordance with some aspects of the invention, produced finished baked goods of comparable volume and shape compared to dry mixes containing conventional, more expensive ingredients (conventional sugar). Additionally, the finished baked goods in accordance with the invention exhibited comparable texture and eating quality attributes. The cake baked with dry mix containing liquid corn syrup was also found to exhibit comparable moistness to the cake baked from a dry mix that did not contain corn syrup. The cakes prepared from dry mixes containing liquid corn syrup, however, had a reduced baked time, with the bake time being reduced from a range of 33-38 minutes to 27-33 minutes, representing a percentage reduction of about 15-18% in total bake time.

### Example 2

### Inclusion of Liquid Corn Syrup in Devils Food Cake Dry Mix

A dry mix for preparing devils food cake was formulated to include liquid corn syrup in partial substitution for sugar as the sweetening agent. This dry mix including liquid corn syrup was compared with a control devils food cake mix that included traditional sweetening agent (without any corn syrup).

A dry mix in accordance with one embodiment of the invention was prepared (Cake Mix B) and compared with a commercially available devils food cake mix (Cake Mix B1) as summarized in Table 2:

TABLE 2
Devils food cake mix including liquid corn syrup
(Cake Mix B) compared with devils food cake mix
containing conventional sugars (Cake Mix B1).

Amount (weight percent)

| Ingredient | Cake Mix B | Cake Mix B1 |
|---|---|---|
| Sugar | 37 | 48 |
| Corn syrup | 5 | — |
| Flour | 39.5 | 33 |
| Fat/emulsifiers | 7 | 6.5 |
| Leavening agents | 2.5 | 2.5 |
| Cocoa, flavors | 6 | 6 |
| Minors | 3 | 4 |
| Total | 100 | 100 |
| Sweetening agent/flour ratio | 0.92 | 1.23 |

Batters were prepared as described in Example 1. Cakes were prepared from the batters as described in Example 1.

The specific gravity of the prepared batters was measured prior to baking. After baking, the cake heights for the baked goods were measured. Results are summarized below:

| | |
|---|---|
| Cake Mix B | Cake Mix B1 |

| Batter specific gravity | 0.8-1.0 | | 0.8-1.0 | |
|---|---|---|---|---|
| Center height | 50-4 | mm | 50-4 | mm |
| Side height | 42-34 | mm | 42-34 | mm |
| Bake Time | 29-34 | minutes | 33-38 | minutes |

The results of this testing showed that dry mixes including liquid corn syrup, in accordance with some aspects of the invention, produced finished baked goods of comparable volume and shape compared to dry mixes containing conventional, more expensive ingredients (conventional sugar). Additionally, the finished baked goods prepared from dry mixes in accordance with the invention exhibited comparable texture and eating quality attributes. The cake baked prepared from dry mixes including liquid corn syrup was also found to exhibit comparable moistness to the cake prepared from dry mixes that did not include corn syrup. Similar to results discussed in Example 1, the cakes prepared from dry mixes containing liquid corn syrup had a reduced baked time as compared to cakes prepared from dry mixes that did not include liquid corn syrup.

### Example 3

### Inclusion of Liquid Corn Syrup in White Cake Dry Mix

A dry mix for preparing white cake was formulated to include liquid corn syrup in partial substitution for sugar as the sweetening agent. This dry mix including liquid corn syrup was compared with a control white cake mix that included traditional sweetening agent (without any corn syrup).

A dry mix in accordance with one embodiment of the invention was prepared (Cake Mix C) and compared with a commercially available white cake mix (Cake Mix C1) as summarized in Table 3:

TABLE 3
White cake mix including liquid corn syrup (Cake
Mix C) compared with white cake mix prepared
with conventional sugars (Cake Mix C1).

Amount (weight percent)

| Ingredient | Cake Mix C | Cake Mix C1 |
|---|---|---|
| Sugar | 32 | 44 |
| Corn syrup | 5 | — |
| Flour | 47.5 | 39.5 |
| Fat/emulsifiers | 9 | 9 |
| Leavening agents | 2.5 | 2.5 |
| Minors | 4 | 5 |
| Total | 100 | 100 |
| Sweetening agent/flour ratio | 0.78 | 1.1 |

Batters were prepared as described in Example 1. Cakes were prepared from the batters as described in Example 1.

The specific gravity of the prepared batters was measured prior to baking. After baking, the cake heights for the baked goods were measured. Results are summarized below:

| | |
|---|---|
| Cake Mix C | Cake Mix C1 |

| Batter specific gravity | 0.7-0.9 | | 0.7-0.9 | |
|---|---|---|---|---|
| Center height | 50-4 | mm | 50-4 | mm |
| Side height | 40-32 | mm | 40-32 | mm |
| Bake Time | 26-31 | minutes | 28-33 | minutes |

The results of this testing showed that dry mixes containing liquid corn syrup, in accordance with some aspects of the invention, produced finished baked goods of comparable volume and shape compared to dry mixes containing conventional, more expensive ingredients (conventional sugar). Additionally, the finished baked goods prepared with dry mixes in accordance with the invention exhibited comparable texture and eating quality attributes. The cake prepared from dry mixes including corn syrup was also found to exhibit comparable moistness to the cake prepared from dry mixes that did not include corn syrup. The cakes prepared from dry mixes containing liquid corn syrup, however, had a reduced baked time (similar to results shown in Examples 1 and 2).

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated. All patents, patent documents, and publications cited herein are hereby incorporated by reference as if individually incorporated. In case of conflict, the present specification, including definitions, will control.

We claim:

1. A shelf stable dry mix composition for use in preparing a baked good, the dry mix comprising:
(a) flour;
(b) sweetening agent, the sweetening agent comprising liquid corn syrup and a second sweetener; and
(c) fat source,
wherein the liquid corn syrup has a moisture content in the range of 16% to 29%, and
wherein the liquid corn syrup is present in an amount of 10% or less by weight, based on weight of the dry mix composition.

2. The dry mix composition according to claim 1 wherein the liquid corn syrup is present in an amount in the range of 2% to 8%, and the dry mix comprises a cake mix or muffin mix.

3. The dry mix composition according to claim 1 wherein the sweetening agent comprises sucrose and liquid corn syrup.

4. The dry mix composition according to claim 4 wherein the ratio of sucrose to liquid corn syrup is in the range of 2:1 to 100:1.

5. The dry mix composition according to claim 1 further comprising a chemical leavening system.

6. The dry mix composition according to claim 1 wherein the sweetening agent to flour ratio of the dry mix composition is reduced relative to a dry mix composition that does not include corn syrup as part of the sweetening agent.

7. The dry mix composition according to claim 6 wherein the sweetening agent to flour ratio is 0.7 to 1.3.

8. The dry mix composition according to claim 1 wherein the sweetening agent to flour ratio is in the range of 0.5:1 to 3.5:1.

9. The dry mix composition according to claim 1 wherein the dry mix exhibits a total moisture content of 5.5% by weight or less, based on total dry mix weight.

10. The dry mix composition according to claim 1 further comprising an emulsifier.

11. The dry mix composition according to claim 1 further comprising a hydrophilic colloid.

12. The dry mix composition according to claim 1 further comprising starch.

13. The dry mix composition according to claim 1 further comprising nonfat dry milk solids.

14. The dry mix composition according to claim 1, wherein the dry mix composition is provided in packaging for storage at ambient temperatures for a period of up to 36 months.

15. A method for making a shelf stable dry mix composition useful for preparing baked goods, the method comprising steps of:
(a) providing a dry preblend comprising flour and sugar;
(b) providing liquid corn syrup to the dry preblend, the liquid corn syrup having a moisture content upon addition to the dry preblend in the range of 16% to 29%, wherein the liquid corn syrup is provided in an amount of 10% or less, based upon total weight of the dry mix composition;
(c) providing a fat/emulsifier component to the dry preblend; and
(d) mixing the flour, sugar, liquid corn syrup and fat component to provide a dry mix composition.

16. The method according to claim 15 wherein the dry mix composition has a moisture content of 5.5% or less, based on total dry mix weight

17. The method according to claim 15 wherein the step (a) comprises providing flour having a moisture content in the range of 8% to 10%.

18. The method according to claim 15 wherein step (b) and step (c) are performed concurrently.

19. The method according to claim 15 wherein the dry mix has a sweetening agent to flour ratio in the range of 0.7 to 1.3.

20. The method according to claim 15 further comprising providing chemical leavening agent to the dry preblend.

21. The method according to claim 15 further comprising providing an emulsifier to the dry preblend.

22. The method according to claim 15, further comprising providing the dry mix composition in packaging for storage at ambient temperatures for a period of up to 36 months.

23. A dry mix for pancakes, comprising:
About 70-90% flour having a moisture content between about 4-10%;
About 4-24% of a fat source;
About 1-4% salt;
About 1-2% of a leavening system; and
About 5-10% corn syrup having a moisture content of about 16-29%.

24. The dry mix of claim 24 wherein in the dry mix is substantially free of any other nutritive carbohydrate sweeteners.
